(19) United States
(12) Patent Application Publication
(10) Pub. No.: US 2003/0218640 A1
(43) Pub. Date: Nov. 27, 2003

(54) System and method for displaying results in tabular and tree views

(75) Inventor: Robin Meryl Noble-Thomas, San Jose, CA (US)

Correspondence Address: Samuel A. Kassatly, 6819 Trinidad Drive, San Jose, CA, 95120, US

(73) Assignee: International Business Machines Corporation

(21) Appl. No.: 10/155,143

(22) Filed: May 24, 2002

(51) Int. Cl. G09G 5/00

(52) U.S. Cl. 345/853

(57) ABSTRACT

A display system and associated method display a result set in either a tree view or a table view. The user has the option to toggle between these two views within the same window. The tree view allows the user to expand on the objects that are containers, and then display the lineage that are contained therewithin. The display system provides the user with the ability to view more information about the returned objects the tree view. The graphical structure of the tree view shows the relationship of parent-child threads, and provides the ability to expand downwardly to lower levels. For each high level node in the tree view, the object's properties are shown in the table view. Thus, the hierarchical architecture for an object can be viewed as well as details in the table view.

### FIELD OF THE INVENTION

The present invention relates in general to a method for user-interactive computer displays and in particular to enhance the user-friendliness of the Graphical User Interface (GUI) display of results returned from search queries

### BACKGROUND OF THE INVENTION

The past decade marked revolutionary technological advances mainly led by both, the consumer electronics industry and the data processing industry. In recent years, the Internet, in general, and eBusiness and eCommerce, in particular, accelerated the development of graphical interface applications. Today, most facets of the computerized enterprise world are based on human-computer interfaces, elevating the demand for easy, user-friendly display interfaces for interactive applications to a necessity.

An exemplary GUI tool is the search agent/engine. Although numerous search agent applications are available, there remain shortcomings for applications utilizing the display of search results in tree views or tree view-table view combinations. For instance, any search engine, which returns objects usually forces the user to open a separate window to see the properties or children related to the object. These shortcomings may be due to one or a combination of the following:

Not allowing toggling between an alternate table view.

Limiting table views to represent details of only one tree node instead of all the high level nodes.

Not displaying both the tree view and the table view in the same window or region.

Thus, there is need for a system that addresses the foregoing shortcomings by enhancing the user-friendliness of the Graphical User Interface display of results returned from search queries. The need for such a system has heretofore remained unsatisfied.

### SUMMARY OF THE INVENTION

The present invention satisfies this need. When search results are returned, some of the returned objects may be containers. Quite often, the user needs to view the children of these objects, which task could prove to be difficult, especially if the objects are returned in a tabular format.

The display of a result set in the form of a tree has been designed to solve this problem. The user would have the option of toggling between viewing the results in a table or a tree. The tree view allows the user to expand on the objects that are containers, and then display the hierarchy, i.e., children, grandchildren, etc., that are contained therewithin. Due to the graphical representation of a tree view, the results returned in a tree view are relatively intuitive to interpret, though limited in providing object properties. On the other hand, the table view allows the user to view the objects and the attributes of each object in a columnar format. Though the tabular format provides numerous object properties, it does not show the relationships to other child objects.

The present invention addresses the problem by providing the user with the ability to view more information about the returned objects in a table view or a tree view. The user can also view more detailed properties of the objects in the a tabular format.

Additionally, the present invention provides a useful tool to help reduce clerical and administrative time spent performing search queries. It renders database searches more effective. It helps improve productivity by providing the most within a search query at a glance, and by presenting this information in a user-friendly Graphical User Interface environment.

Another feature of the present invention is the ability to toggle between the table view and the tree view, within the same window. The graphical structure of the tree view shows the relationship of parent-child threads, and provides the ability to expand downwardly to lower levels. For each high level node in the tree view, the object's properties are shown in the table view. Thus, the hierarchical architecture for an object can be viewed as well as details in the table view.

### BRIEF DESCRIPTION OF THE DRAWINGS

The various features of the present invention and the manner of attaining them will be described in greater detail with reference to the following description, claims, and drawings, wherein reference numerals are reused, where appropriate, to indicate a correspondence between the referenced items, and wherein:

FIG. 1 is a schematic illustration of an exemplary operating environment in which a display system of the present invention can be used;

FIG. 2 is an example screen shot that illustrates returned search results in a table view;

FIG. 3 is an example screen shot that illustrates the returned search results of FIG. 2 in an unexpanded tree view;

FIG. 4 is a flowchart illustrating the operation of a preferred embodiment of the display system of the present invention; and

FIG. 5 is a screen shot that illustrates an example tree view that has been expanded by the display system of the present invention.

### DETAILED DESCRIPTION OF PREFERRED EMBODIMENTS

The following definitions and explanations provide background information pertaining to the technical field of the present invention, and are intended to facilitate the understanding of the present invention without limiting its scope:

Node: Refers to an element, or object which can be expanded to show underlying objects.

Element: An object representing one of the rows returned from the search query. An element may comprise another element.

Attribute: A pair such as name=“value” which represents a property (for instance, Unique ID “icmdbname.RELATIONAL” is an attribute for the element “icmdbname”).

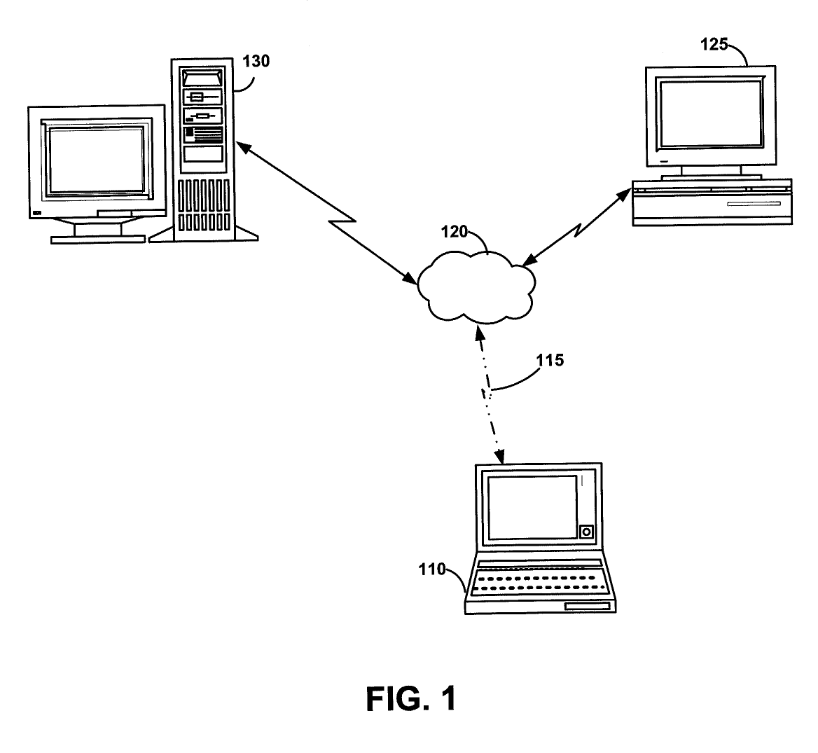

FIG. 1 portrays an environment where a display system of the present invention may be used. The display system includes a software or computer program product that is typically embedded within or installed on, for example a computer or a host server 110. Alternatively, the display system can be saved on a suitable computer usable medium such as a diskette, a CD, a hard drive, or like storage devices. While the display system will be described in connection with query searches, the display system can be used with a stand-alone database of documents or other text sources that may have been derived from the WWW or other sources.

Computer 110 includes a Graphical User Interface based software that allows the user to conduct a search query. The search may be contained within computer 110 or it may span targets on a network 120. The dashed relational line 115 indicates an optional connection reflecting a network application through the cloud-like representation (120) or a stand alone application limited to computer 110. The cloud-like representation represents a network which may be a Local Area Network, a Wide Area Network, an Intranet scheme, or the World Wide Web.

Computer 125 is connected to the network 120, and may represent the target of the search query performed by computer 110 or it may be the initiator of another search query. Computer 130 is connected to the network 120, and may be an end user, a database server, or a communications server, which in turn, may be connected to another network via a telephone, cable, or satellite link.

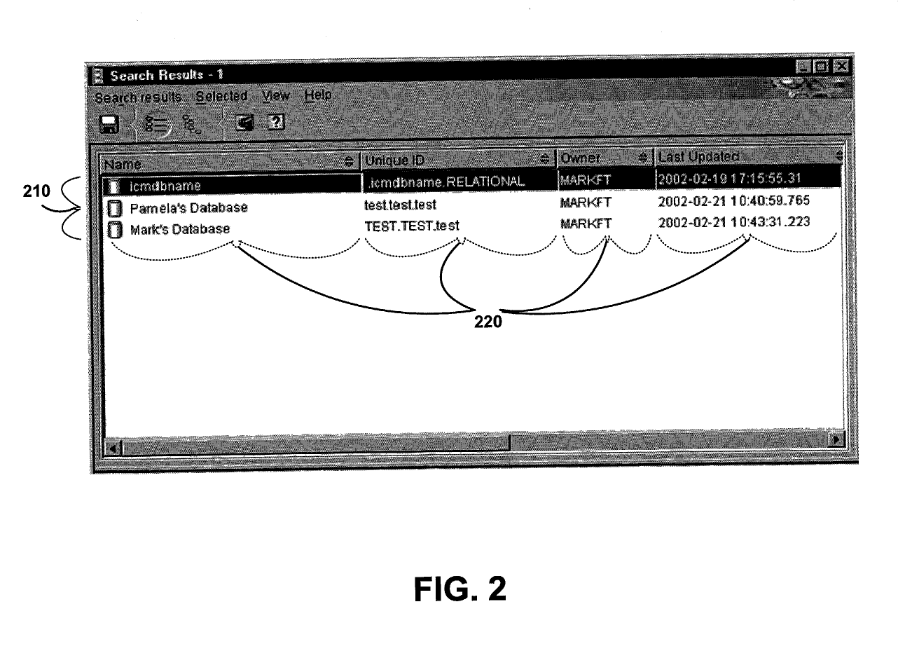

FIG. 2 illustrates the returned search results in a tabular format. Each of the rows denoted by the numeral reference 210 is an object that is returned as a result of the search query. In this table view, there are three objects: icmdbname, Pamela's Database, and Mark's database. The columns of the table are referenced by the numeral reference 220, each of which represents a property of the object. The left most column property indicates the object's name. This is followed by the object's unique ID, which in turn is followed by the owner's userid. The right most column property indicates the date at which the object was last updated. It should be noted that while in the table view, the properties of each object are clearly shown, this view does not show the relationships to lower level objects or children.

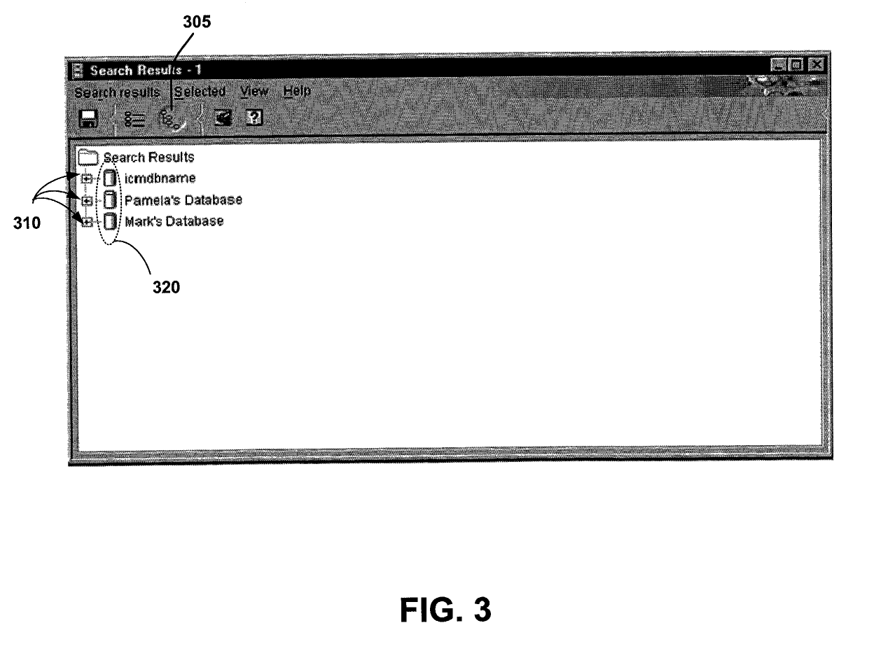

The screen shot of FIG. 3 shows the returned search results in an unexpanded tree view. This view is reached by selecting a tree view icon 305 on the toolbar that toggles to the tree view. Each of the nodes denoted by 310 is an object that is returned as a result of the search query. Nodes 310 parallel the objects 210 of FIG. 2.

In the tree view of FIG. 3, there are three objects: icmdbname, Pamela's Database, and Mark's database. Clicking the “+” symbol expands a parent node into its children nodes. Clicking the “−” symbol collapses the children nodes reverting to the parent node. In this case, the “+” symbol indicates that there are hierarchical relationships within each of these objects 310 with only the names displayed. Though specific symbols, such as the “+” and “−” symbols are used herein as exemplary symbols, it is clear that other symbols could alternatively be used to perform the same or similar functions.

The container mentioned earlier is referenced by the numeral reference 320. The icon shown with the object's name indicates the type of that object.

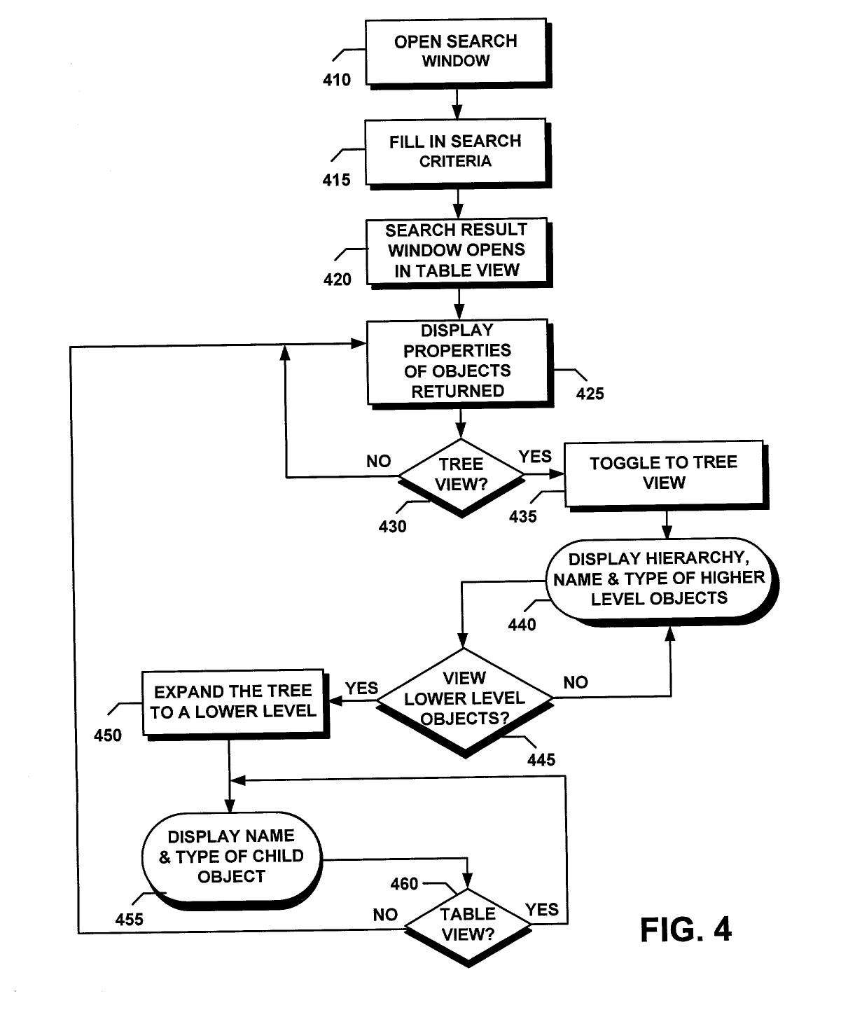

FIG. 4 is a flowchart that illustrates the logic of a preferred embodiment of the display system of the present invention. At step 410, the user opens a GUIbased search window. At step 415, the user fills in the search criteria. Search parameters may include name, content, size, creation date or last modification date.

At step 420, a search result window opens for example in a tabular format, by default. This is to maximize the number of properties displayed. At step 425, the properties of the returned search results are displayed in the table view. Typical table view properties are illustrated in FIG.2.

At decision step 430, the system checks if the user is opting for a tree view. If so, the display system proceeds to step 435; else, it reverts back to step 425. At step 435, the display system toggles to a tree view, within the same window. At step 440, the tree view provides the hierarchy, name, and type of the higher level objects in one window. Typical unexpanded tree view nodes are illustrated in FIG.3.

The display system them proceeds to decision step 445, where it checks if the user has opted to explore lower level objects from the tree view hierarchy. If so, the display system expands the tree view to a lower level at step 450; otherwise, the display system keeps the window displayed at step 440.

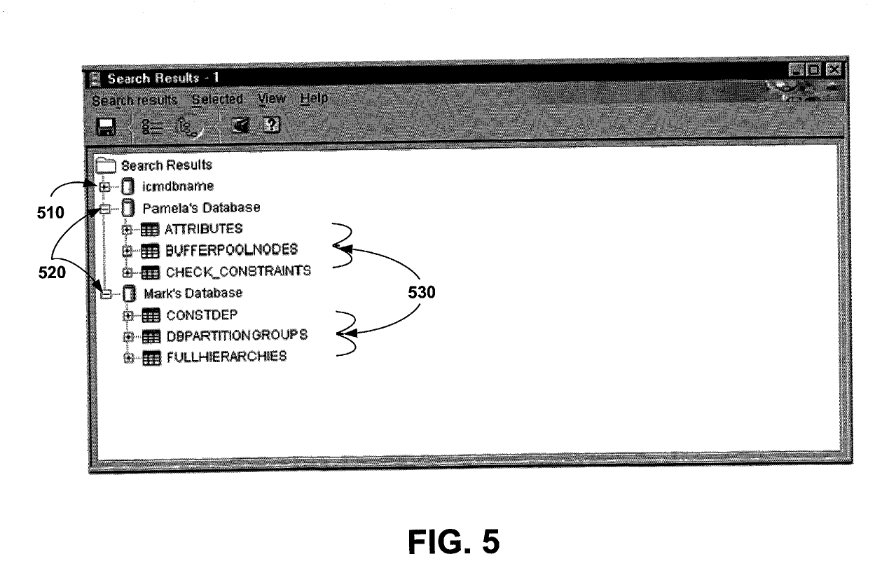

At step 455, the name and type of the lower level results (or children) are displayed in the tree view. Typical expanded tree view objects are illustrated in FIG.5.

At decision step 460, the display system checks if the user has opted for a table view. If so, the display system returns to step 425, else, it reverts back to step 455.

Referring now to FIG. 5 portrays an example of an expanded tree view (step 455 of FIG.4). Numeral reference 510 denotes an unexpanded higher level node as indicated by a “+” symbol. Its name property is “icmdbname”. Numeral reference 520 denotes two expanded higher level nodes, as indicated by a “−” symbol. Their name properties are Pamela's Database and Mark's database respectively. This FIG. 5 is a detailed version of the tree view in FIG. 3.

Numeral reference 530 denotes unexpanded lower level nodes. Without opening additional windows, the hierarchical information is presented in the expanded tree view.

It is to be understood that the specific embodiments of the present invention that are described herein are merely illustrative of certain applications of the principles of the present invention. Numerous modifications may be made without departing from the scope of the invention. For instance, the field of the invention is not limited to search results, it may be extended to file systems or any data with a hierarchical architecture.

What is claimed is:

1. A method for displaying hierarchical data as objects in a tree and table views, comprising:
within a window, displaying a list of high level objects in a table view with properties shown in columns;
within the window, displaying hierarchical relationships of the objects by toggling to a tree view; and
expanding the tree view to show underlying objects and corresponding properties.

2. The method of claim 1, further comprising toggling to the table view from the tree view, within the window.

3. The method of claim 2, wherein a row in a table view represents an object and a column shows a property corresponding to the object.

4. A computer program product for displaying hierarchical data as objects in a tree and table views, comprising:
a first set of instruction codes that displays a list of high level objects in a table view with properties shown in columns, within a window;
a second set of instruction codes that displays hierarchical relationships of the objects by toggling to a tree view within the window; and
a third set of instruction codes that expand the tree view to show underlying objects and corresponding properties.

5. The computer program product of claim 4, further comprising a fourth set of instruction codes that toggle to the table view from the tree view, within the window.

6. The computer program product of claim 5, wherein a row in a table view comprises an object and a column comprises a property corresponding to the object.

7. A display system that displays hierarchical data as objects in a tree and table views, comprising:
means for displaying a list of high level objects in a table view with properties shown in columns within a window;
means for displaying hierarchical relationships of the objects by toggling to a tree view within the window; and
means for expanding the tree view to show underlying objects and corresponding properties.

8. The display system of claim 7, further comprising means for toggling to the table view from the tree view, within the window.

9. The display system of claim 8, wherein a row in a table view represents an object and a column shows a property corresponding to the object.

10. A computer usable medium having instruction codes for use with a display system that displays hierarchical data as objects in a tree and table views, comprising:
a first set of instruction codes for displaying a list of high level objects in a table view with properties shown in columns, within a window;
a second set of instruction codes for displaying hierarchical relationships of the objects by toggling to a tree view within the window; and
a third set of instruction codes for expanding the tree view to show underlying objects and corresponding properties.

11. The computer usable medium of claim 10, further comprising a fourth set of instruction codes that toggle to the table view from the tree view, within the window.

12. The computer usable medium of claim 11, wherein in a table view, a row comprises an object and a column comprises a property corresponding to the object.
